(19) United States
(12) Patent Application Publication
(10) Pub. No.: US 2008/0165004 A1
(43) Pub. Date: Jul. 10, 2008

(54) Packaging of Transponder Devices

(75) Inventors: James Thomas Edward McDonnell, Bristol (GB); Cynthia S. Nickel, Wimberley, TX (US); David Neil Slatter, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/666,236

(22) PCT Filed: Oct. 26, 2005
(86) PCT No.: PCT/EP05/55568

§ 371 Date: Nov. 5, 2007

(30) Foreign Application Priority Data
Oct. 29, 2004 (GB) 0424162.6

(51) Int. Cl. G08B 13/14

(52) U.S. Cl. 340/572.1

(57) ABSTRACT

A packaged product comprises a physical product, an inductively powered transponder device having a memory containing digital content, and a packaging. The packaging is adapted to prevent sufficient signal from reaching an antenna of the inductively powered transponder device to enable the digital content to be read from the memory.

### FIELD OF THE INVENTION

The invention relates to packaging of transponder devices. It concerns, in aspects, both methods of packaging transponder devices and packaged transponder devices.

### BACKGROUND TO THE INVENTION

Transponder devices respond to an input signal by giving an output signal in response. The input signal, in many classes of transponder, serves to power the transponder. A widely used form of transponder device is the RFID tag—radio frequency power from a reader device is received by an antenna of the RFID tag. The RFID tag is powered and transmits data in the form of an identifier by modulation of the power received. The present applicants have proposed forms of transponder device, powered in a similar manner to RFID tags but designed to be read at short range and with memories for storing significant digital content.

In some circumstances, a user may not wish transponder devices to emit data. Suggested approaches for addressing this are destruction of the RFID tag by irradiating it with high power microwaves or jamming of an area by providing spurious simulated RFID signals to overwhelm a reader device and prevent it from using an anti-collision protocol to disentangle responses effectively. These approaches are stimulated by privacy concerns and are not suitable for efficient distribution of digital content on transponder devices.

### SUMMARY OF THE INVENTION

In one aspect, the invention provides a packaged product comprising a physical product, an inductively powered transponder device having a memory containing digital content, and a packaging, the packaging being adapted to prevent sufficient signal from reaching an antenna of the inductively powered transponder device to enable the digital content to be read from the memory.

### DESCRIPTION OF DRAWINGS

Specific embodiments of the invention will now be described, by way of example, with reference to the accompanying drawings, of which:

FIG. 1 shows a schematic circuit diagram for a transponder tag for which embodiments of the invention may be used together with a suitable tag reader;

FIG. 2 shows a schematic representation of the transponder tag of FIG. 1;

FIGS. 3A and 3B show transponder tags as shown in FIG. 1 used as primary products and as ancillary products;

FIGS. 4A and 4B show packaging for a transponder tag according to a first embodiment of the invention;

FIGS. 5A and 5B show packaging for a transponder tag according to a second embodiment of the invention;

FIGS. 6A and 6B show packaging for a transponder tag according to a third embodiment of the invention;

FIGS. 7A, 7B and 7C show packaging for a transponder tag according to a fourth embodiment of the invention;

FIGS. 8A and 8B show packaging for a transponder tag according to a fifth embodiment of the invention; and

FIG. 9 shows a flow diagram indicating a process of packaging a transponder tag in accordance with embodiments of the invention.

### DESCRIPTION OF SPECIFIC EMBODIMENTS

Embodiments of the invention are useful for packaging of transponder devices which are conventional RFID tags—such tags are described in many reference sources, for example “RFID Handbook”, Klaus Finkenzeller, 1999, John Wiley & Sons. However, particular value can be realised in packaging of transponder devices with significant memory—sufficient to store significant digital content rather than just identifier data—and an exemplary device of this kind (termed here “memory tags”) is described below. The type of memory tag discussed here is designed to be read by a suitable reader device at close range and to provide rapid data transmission—data can thus be read by “brushing” the reader device across the memory tag.

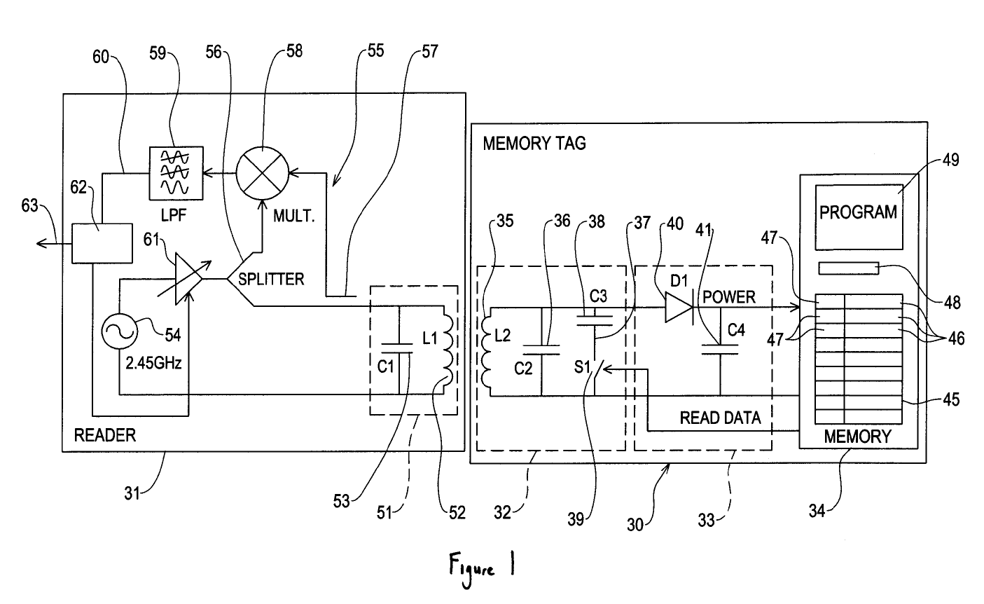

Referring now to FIG. 1, a memory tag of this kind is shown at 30 and a suitable reader shown at 31. The tag 30 comprises a resonant circuit part 32 and a rectifying circuit part 33, together with a non-volatile memory 34. The resonant circuit part 32 comprises an inductor L2 shown at 35 and a capacitor C2 shown at 36 connected in parallel. The resonant circuit part 32 further comprises a controllable capacitive element generally indicated at 37, in the example of FIG. 1 comprising a capacitor C3 shown at 38 and a switch S1 shown at 39. The rectifying circuit part 33 comprises a diode D1 shown at 40 connected to the resonant circuit part 32 in a forward biased direction and a capacitor C4 shown at 41 connected in parallel with the components of the resonant circuit part 32. The rectifying circuit part 33 operates as a half-wave rectifier to provide power to the memory 34.

The memory 34 comprises a data store generally illustrated at 45 comprising a plurality of data units 46. A program 49 controls the behaviour of the memory tag.

The reader 31 comprises a resonant circuit part 51 which comprises an inductor L1 shown at 52, in this example an antenna and a capacitor C1 shown at 53 connected in parallel. A signal generator 54 is connected to the resonant circuit part 51 to provide a drive signal.

The reader 31 further comprises a demodulator, generally shown at 55. The demodulator 55 comprises a splitter 56 connected to the frequency generator to split off a part of the drive signal to provide a reference signal. A coupler 57 is provided to split off part of a reflected signal reflected back from the resonant circuit part 51, and pass the reflected signal to a multiplier shown at 58. The multiplier 58 multiplies the reflected signal received from the coupler 57 and the reference signal received from the splitter 56 and passes the output to a low pass filter 59. The low pass filter 59 passes a signal corresponding to the phase difference between the reference signal and the reflected signal to an output 60. An amplitude modulator is shown at 61 operable to control the amplitude of the drive signal supplied from the frequency generator 54 to the resonant circuit part 51.

A control unit 62 is operable to receive the output 60 from the low pass filter 59 and validate the received data. The control unit 62 is also operable to control the amplitude modulator 61.

A signal comprising a data unit is transmitted to the reader 31 by operating switch S1 shown at 39. This varies the resonant frequency of the resonant circuit part 32. This change in resonant frequency causes the phase of the signal reflected from the resonant circuit part 51 to vary with respect to the signal provided by the signal generator 54. This relative phase shift can be processed by the multiplexer 58 and low pass filter 59 to produce a digital output 63 as described in our earlier co-pending application published as GB2395628A.

When the tag 30 is moved sufficiently close to a reader 31 so that inductive coupling can be established between the resonant circuit parts 51, 32, power will be supplied to the memory 34 to run the program 49 and render the tag operational. A central part of tag operation is to transmit the data units 46 held in the data store 45. These are read from the data store 45 and transmitted as a part of a packet by operation of switch S1 under operation of the program 49.

It is particularly desirable that the tag 30 be provided as an integrated circuit, for example as a CMOS integrated circuit. A schematic of such an integrated circuit is show at 80 in FIG. 2. The inductor L2 is shown at 35, here as an antenna coil having only a single turn although any number of turns may be provided as appropriate. The capacitor C4 is shown at 41, and the remaining components of the resonant circuit part and rectifying circuit part 33 are shown at block 81. The memory is shown at 34. The memory 34 may provide 1 Mbit or greater capacity of non-volatile memory and may use FRAM (ferroelectric random access memory) or MRAM (magnetoresistive random access memory) or another memory technology with low power usage. An exemplary memory tag 30 may have sides of the order of 1 mm in length.

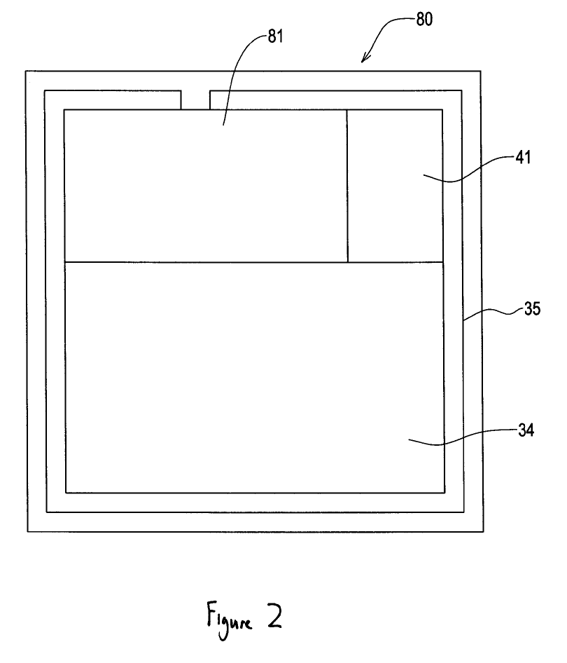

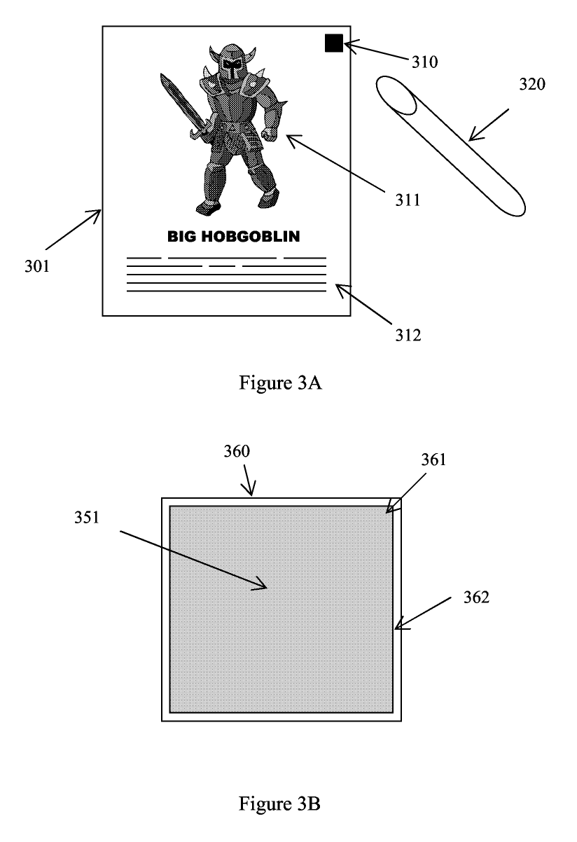

Use models for transponder tags—both of the type shown in FIGS. 1 and 2 and also of conventional RFID tags—are shown, by way of example, in FIGS. 3A and 3B. FIG. 3A shows a product 301—in this case with the form factor of a card—of which a transponder tag 310 forms an integral part. This card 301 has images 311 and text 312 but also digital content stored on transponder tag 310—such tags will be termed memory tags below. Digital content may be digital media (music, video etc.) or other useful content (for example, software). A card is not the only form factor for a product which includes a transponder tag—the form factor of a transponder tag is such that it may be integrated into almost any tangible product.

For completeness, FIG. 3A also shows a reader device 320. As indicated above in respect of FIG. 1, this reader device is adapted to power a transponder tag 310 and read data from it at close range over a short period of time. This reader 320 may itself be a computing device, or may be a peripheral to one (for example, to a PDA with which it communicates by wire or by a wire replacement networking technology such as Bluetooth).

FIG. 3B shows a product 351 for which a transponder tag 361 forms part of the packaging rather than a part of the product itself. In this case, the transponder tag 361 is formed on a backing sheet 360 forming part of the product packaging. The packaging is completed by a bonded transparent front sheet 362 which retains the product 351. This packaging form factor is simply exemplary—embodiments of the invention as described below can be applied to almost any form of packaging. Such a transponder tag may be a conventional RFID chip, or could indeed be a memory tag as described above, depending on its required function.

Various embodiments of the invention will now be described, embodiments among these being relevant to the inclusion of transponder devices within products as shown in FIG. 3A and embodiments among these being relevant to the inclusion of transponder devices within the packaging of products as ancillary to, but not as part of, the products themselves as shown in FIG. 3B.

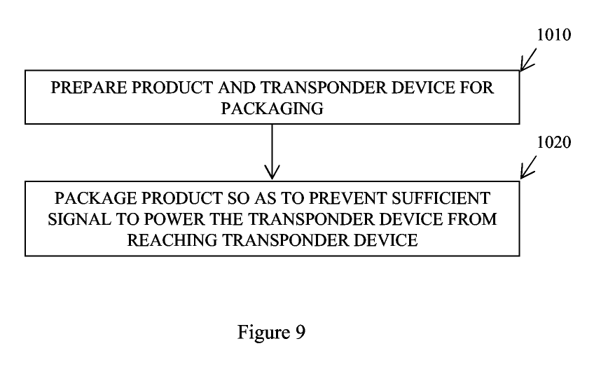

From the perspective of a method of packaging, these are illustrated by the flow diagram of FIG. 9. The first step is preparation of the product for packaging (1010). This may include the programming of a transponder device, such as a memory tag, within the product with digital content. It may also include the preparation of a transponder device ancillary to the product to be prepared—for example an RFID chip containing a product code. The second step is packaging of the product so as to prevent sufficient signal to power the transponder device from reaching the transponder device (1020). After (most typically) purchase of the packaged product, the end user is then able to remove or modify the packaging to allow RF signal to reach the transponder device.

There are at least two reasons for preventing the transponder device from receiving enough signal to power it. One is to prevent content theft. If valuable digital content is contained within the transponder device—especially if this digital content is a central part of the product—then placing the full product on open shelves attracts a risk that dishonest users will upload the content from the transponder device without purchasing the product. Another reason is to prevent content modification. For transponder devices that can be written to as well as merely read from, there is a risk that on being powered, the spot will be written to and its content changed (which may be disadvantageous if data in the transponder device memory has, for example, a security function).

It is possible to prevent sufficient signal from reaching the transponder device to power it in alternative ways. A first way of doing this is to construct a Faraday cage around the transponder device. This may be achieved by surrounding the transponder device with a metal layer of sufficient depth that insufficient signal can penetrate to power the transponder device. While this is dependent on the power of the reader device, the power that can be provided by a reader is practically limited (by regulatory requirements from danger to the user or others, from picking up signal from other transponders not so protected) so an effective practical shield can be provided by a sufficient thickness of metal.

Thickness is best considered in terms of skin depth—this can be defined as the distance an electromagnetic wave must travel in a lossy medium to reduce by 1/\acute{∈} (approximately 36.8%). The skin depth is determined by the operating frequency and the resistivity of the metal as follows:

TABLE 1
skin depth calculation

$δ = \sqrt{\frac{2 ρ}{2 \text{?} f {μ}_{0}}} ( meters ) \text{?}$ $\text{?} \text{indicates text missing or illegible when filed}$
ρ = resistivity(ohm − meters)
f = frequency (Hz)
μ₀ = 4 [symbol] 10⁻⁷ (Henries/meter) [symbol]
indicates data missing or illegible when filed

For operation at 2.45 GHz—a preferred value for memory tags—this provides skin depths for common metals of the following:

Aluminium—2 μm;

Tin—3.4 μm;

Copper—1.4 μm.

This compares to a typical thickness of a sheet of paper of about 100 μm. To shield a transponder device effectively, it is desirable to provide a metal thickness of at least five times the skin depth (preferably 10 times). It is apparent from the above that this can be achieved with either a metal foil, or with a free-standing metal structure.

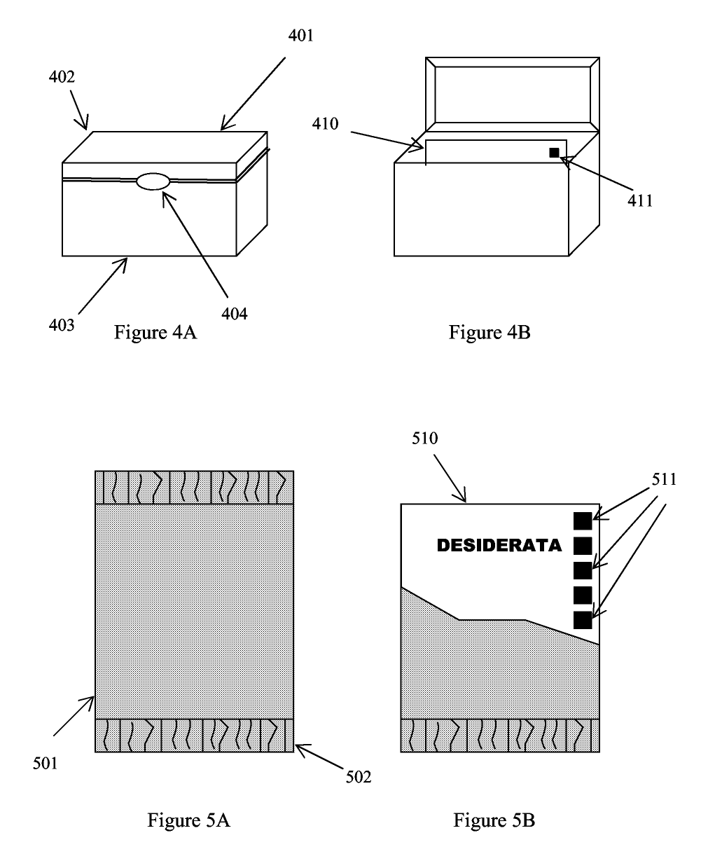

A first embodiment is shown in FIGS. 4A and 4B. A box 401 is constructed from metal sheet of appropriate thickness (greater than five times the relevant metal skin depth, but probably many times this to ensure structural stability and strength in the box). The box may also be constructed from laminar sheet which is not wholly metal, but which contains a metal layer of sufficient thickness. The box may be constructed in a number of ways, but a suitable low cost option is stamping of the metal sheet with a die and folding of the stamped pieces to form a body part 403 and a lid part 402. When the product 410 (with transponder device ready for operation) has been inserted, the body part 403 and the lid part 402 are sealed together with a seal 404. On purchase of the product, the user may break the seal 404 whereupon the box 401 can be opened and the product 410 (in this case a card) extracted. The closed box 401 forms a Faraday cage. As soon as the box 401 is opened, it becomes possible to power the transponder device 411 on the product 410.

A second embodiment is shown in FIGS. 5A and 5B. The packaging 501 is formed of a foil tube bonded top and bottom with appropriate bonding areas 502. Such bonding can be achieved in any conventional manner for packaging of this type, such as by compressing the foil at the bonding areas at elevated temperature to melt a bonding layer of the foil. While such foils may be constructed wholly of metal of appropriate thickness, a suitable option is to use a laminar foil which contains a layer of metal within layers of plastics material, including a layer on the inside of the tube which will partially melt to form a bonding area. On purchase of the product, the foil tube may be ripped open by the user as shown in FIG. 5B to reveal the product 510, in this case a card bearing a plurality of transponder devices 511—these may be, for example, discrete music tracks on an album available for upload piecemeal to, say, an MP3 player.

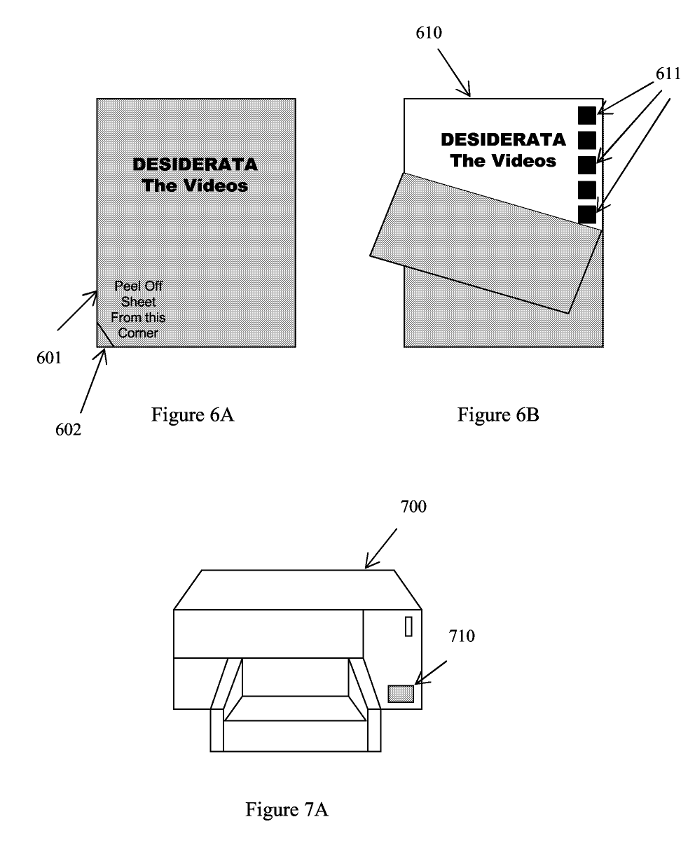

A third embodiment is shown in FIGS. 6A and 6B. In this embodiment, the product is again a card, as can be seen in FIG. 6B—in this case a collection of videos each video being stored on a separate transponder device. Only the front side of the packaging is shown in FIG. 6A. This front side comprises a sheet 601 adapted to be peeled off from a corner 602 by an end user of the product. Sheet 601 contains a sufficiently thick layer of metal to prevent the memory tags 611 on card 610 (in this case, a card containing a number of video clips, each in a separate memory tag 611) from being powered from the front side. Sheet 601 is here a laminate containing a metal layer bounded by plastics material layers, with a weakly bonding adhesive layer on the inner surface of the sheet where it contacts the card—this weakly bonding layer may be, for example, of any conventional variety used in packaging for fixing removable labels to products.

Sheet 601 clearly only shields memory tags 611 from the front. A comparable metal layer is needed on the reverse—this may be another sheet similar to sheet 601, or it may be a fixed part of the card 610 (as if sheet 601 is removed, then access to the memory tags from the front is possible and unhindered by shielding to the rear). This arrangement is not a true Faraday cage, however, as there is no metal on the edges of the card. While this could be addressed by design (for example, by sheet 601 wrapping around the edges and overlapping the back of the card), this is not necessary for producing a practical embodiment. If, as in most designs of memory tag, the antenna of the transponder device lies in the plane of the card 610, provision of power by a reader directly on to the edge will not cause significant power to be coupled into the antenna because the angle of incidence of the radiation is such that it will not illuminate the antenna. For a memory tag, the operational power requirements are significantly lower than for the simplest of RFID tags, so such side-illumination is particularly unlikely to cause difficulty in the case of memory tags, especially if the memory tag is located some distance from the edge of the card. A suitable design of memory tag, discussed in EP-A-1422658, is adapted to be read only at distances of less than 10 D, where D is an external dimension of the memory tag. The skilled person will appreciate that the design needs to be such so as not to act as a particularly effective waveguide—this can be determined readily by experiment.

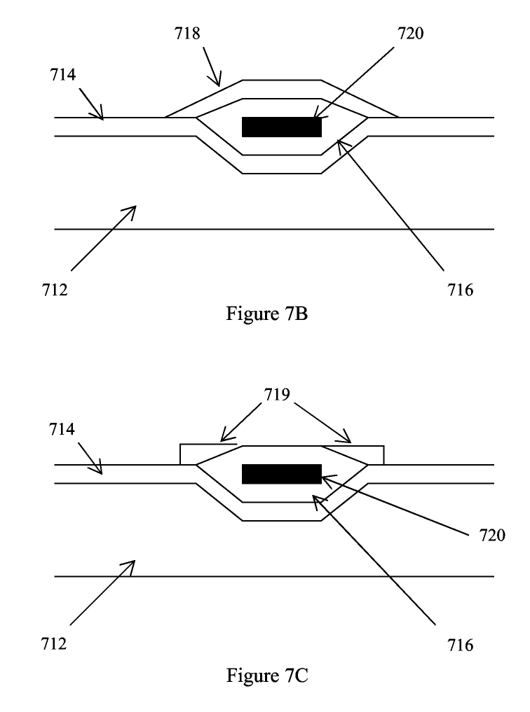

A fourth embodiment is shown in FIGS. 7A, 7B and 7C. FIG. 7A shows a printer 700 with a packaged transponder device 710 containing digital content. It should be appreciated that this embodiment may be applied with card products (as described for previous embodiments) and likewise the previous embodiments may equally be adapted for printers or any other product which may usefully include, or have associated with it, a transponder device.

Packaged transponder device 710 is shown in more detail in FIG. 7B, which provides a cross-sectional view. A substrate 712 has deposited on it or bonded to it a metal layer 714 of sufficient thickness to provide shielding against a reader. In some contexts (a card, for example) this metal layer should be capable of withstanding some degree of deformation. The transponder device 720 is placed in a small recess in the substrate 712, the recess around the transponder device 720 being filled with a latex filler material 716. Over the top of the latex filler material there is painted a layer of metallic ink 718—again, this layer must be of sufficient thickness to provide effective shielding against a reader device, as discussed above. Metallic ink 718 and metal layer 714 thus provide a Faraday cage to shield the transponder device against powering up.

An end user enables activation of the transponder device 720 by scratching away at least a part of the metallic ink layer 718. This is shown in FIG. 7C. The major part of the metallic ink has been scratched away, leaving metallic ink remnants 719. The removal of the metallic ink means that the transponder device 720 can now be powered from the open side left by the removal of the ink.

It will be appreciated that in this arrangement, metallic ink 718 could be replaced by a small peelable metal sheet of the type shown in FIG. 6A (but covering only the recess rather than the whole surface). It will also be appreciated that the latex filler 716 needs both to protect the transponder device 720 against the scratching off of the metal layer and to prevent the transponder device from being scratched out of the recess when the metallic ink layer is removed.

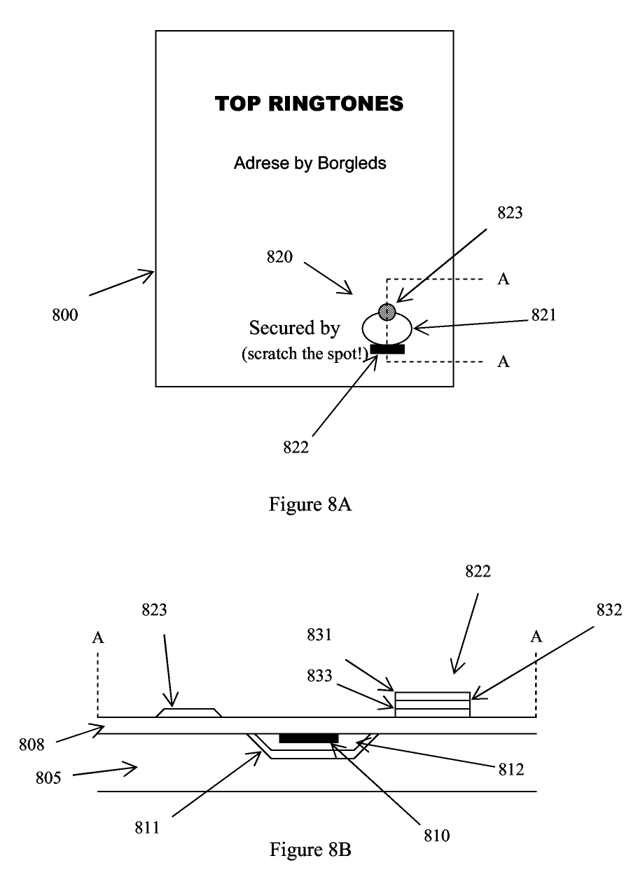

As discussed above, it is possible to prevent sufficient signal from reaching the transponder device to power it in alternative ways. A second way of doing this is to absorb RF power from a reader before it reaches the transponder device. This may be achieved by arranging one or more absorbing devices in the packaging to prevent sufficient signal to power the transponder device being received by the transponder device. This approach may be combined with the previously discussed approach: power received from one direction may be absorbed, and in another direction shielded. This is described in more detail with reference to a fifth embodiment of the invention shown in FIGS. 8A, 8B and 8C.

FIG. 8A shows a card product 800 which has an absorbing device structure 820 on the surface to prevent power from reaching a transponder device underneath it. The absorbing device structure 820 comprises an antenna loop 821 and a load region 822. Any antenna loop will require some measure of shielding for the memory tag—provided that it is not coupled with the memory tag antenna—and the precise degree of shielding required will be determined by the power requirements of the memory tag and the power provided by the reader. A particularly effective antenna loop may be of the same dimensions as that in a standard reader device, thus providing particularly effective coupling of power into the antenna loop—however, satisfactory coupling of power into the antenna loop may as indicated above be achieved with a wide range of antenna designs. The antenna loop has within it a scratch-off region 823. The whole of the antenna loop 821 may if preferred be constructed as a scratch-off region. Load region 822 contains lossy dielectric material—again, some shielding will be provided without any lossy region (the antenna may simply be a conductive loop) and this may for practical purposes be sufficient, but use of lossy dielectric material improves the shielding effect. The absorbing device structure 820 will be most effective in coupling power from the reader if it resonates at the operating frequency of the reader—however, it need not resonate at this frequency to be absorbing enough to be effective, particularly if the transponder device is a memory tag requiring more power for operation than a basic RFID device. The absorbing device structure 820 may have a characteristic form—giving it a potential use as a badge of quality guaranteeing a certain level of security for digital content in the transponder device. It is desirable in any event for there to be good visual contrast between the antenna loop 821 and the underlying substrate to enable an observer to check visually the antenna integrity.

FIG. 8B provides a cross section (along line A-A in FIG. 8A) through the card product 800 and illustrates in greater detail the load region 822 and the scratch-off region 823 of the antenna loop 821. Also illustrated is the transponder device 810, which is disposed in a recess in substrate 805. The recess is lined with a metallic layer 811 of sufficient thickness to shield the transponder device 810—if there is sufficient thickness of material behind the transponder device 810 to prevent the reader to transponder device distance from being sufficiently small to allow effective reading, then this may not be required. The transponder device 810 is located in the recess within a layer of latex filler material 812. An insulating layer 808 is deposited over the top.

Over this insulating layer, both the antenna loop 821 and the load region 822 of the absorbing device are formed. The formation of these layers can be achieved by contact printing using appropriate pastes (insulating or conductive as appropriate). The scratch-off region 823 of the antenna loop is formed of a conductive paste that may be manually removed by and end user to break the antenna loop and thus prevent the absorbing device from absorbing power from the reader. The only requirements on this layer are that it is sufficiently bulky to provide good conductivity around the antenna loop so that the antenna is an effective antenna—skin depth is not a consideration. In the load region 822, three layers are stacked up—the top layer 831 and the bottom layer 833 are both conductive, and each is connected to a different arm of the antenna loop 821. Top layer 831 and bottom layer 833 form overlaid pads. Between these layers is a lossy dielectric layer 832. This layer is chosen so as to effectively draw power from the illumination by the reader and prevent sufficient power from passing to the transponder device 810. Other designs of load region 822 may be adopted—for example, each antenna loop limb may terminate in a set of fingers, the fingers of each limb interdigitating but being separated by a lossy dielectric region. This arrangement would allow for one less printing step (there would need to be only one rather than two printing steps for conductive material, as there would no longer be conductive material overlying other conductive material). As indicated above, if limited shielding only is required then the load region may be dispensed with altogether.

It is desirable for the whole of the antenna region to be protected against tampering (particularly invisible tampering). One possible option is to provide in-store conductivity testing so that the resistance across the antenna loop is found to be appropriate (in a similar manner to in-store or on-package battery testing).

If appropriate (for example in the case of a card) a similar shielding antenna loop could be provided on the rear side (possibly instead of a metal layer behind the transponder device 810).

The skilled person will appreciate that the range of approaches for packaging inductively powered devices so as to prevent sufficient power from reaching the devices to power them can be applied to a wide range of products and packaging form factors, and that different approaches (such as shielding and absorbing) can be used effectively in combination. While the discussion here mainly relates to packaging of items for presentation to potential customers in a store, this is not the only field of application. Similar packaging may be adopted for mailing items or otherwise sending them in transit in order to prevent unauthorised review of such items in transit. The bag constructed from a foil tube shown in FIG. 5A could for example be used as a mailing package.

1. A packaged product comprising a physical product, an inductively powered transponder device having a memory containing digital content, and a packaging, the packaging being adapted to prevent sufficient signal from reaching an antenna of the inductively powered transponder device to enable the digital content to be read from the memory.

2. A packaged product as claimed in claim 1 wherein the inductively powered transponder device is integrated with the physical product.

3. A packaged product as claimed in claim 1 wherein the inductively powered transponder device is integrated with the packaging.

4. A packaged product as claimed in claim 1 wherein the packaging is adapted to at least partially shield the antenna with a metallic layer of at least five times the skin depth at an operating frequency of the inductively powered transponder device.

5. A packaged product as claimed in claim 4, wherein the packaging forms in the packaged product a Faraday cage around the inductively powered transponder device.

6. A packaged product as claimed in claim 5, wherein the packaging comprises a box formed of material comprising the metallic layer.

7. A packaged product as claimed in claim 5, wherein the packaging comprises a bag comprising the metallic layer.

8. A packaged product as claimed in claim 4, wherein the packaging comprises at least one metallic layer extending beyond the antenna on projection onto a plane of the antenna.

9. A packaged product as claimed in claim 8, wherein the packaging comprises a metallic layer removably attached to a surface of the product.

10. A packaged product as claimed in claim 9, wherein the metallic layer is comprised in a peelable foil.

11. A packaged product as claimed in claim 9, wherein the metallic layer is comprised in a scratch-off region.

12. A packaged product as claimed in claim 1, wherein the packaged product comprises an absorbing device having an antenna and a load to prevent sufficient signal from reaching the antenna of the inductively powered transponder device.

13. A packaged product as claimed in claim 12, wherein the absorbing device has a scratch-off region to prevent it from absorbing signal.

14. A packaged product as claimed in claim 13, wherein the scratch-off region comprises a conductive track forming at least a part of the antenna of the absorbing device.

15. A packaged product as claimed in claim 12, wherein the load of the absorbing device is adapted for resonance at an operating frequency of the inductively powered transponder device.

16. A packaged product comprising an inductively powered transponder device having a memory containing digital content, the package comprising a conductive removable layer preventing power from reaching an antenna of the inductively powered transponder device.

17. A packaged product as claimed in claim 16 where the removable layer is a scratch-off layer.

18. A packaged product as claimed in claim 16 where the removable layer is a peelable layer.

19. A packaged product as claimed in claim 16, wherein the removable layer comprises a metallic layer of at least five times a skin depth at the operating frequency of the inductively powered transponder device and at least partially shields the antenna.

20. A packaged product as claimed in claim 16, wherein the removable layer comprises a conductive track forming part of an absorbing device circuit preventing signal from being received by the antenna of the inductively powered transponder device, the absorbing device circuit comprising an antenna and a load.

21. A method of packaging a product comprising an inductively powered transponder device having a memory containing digital content, comprising: physically associating the inductively powered transponder device with the product; writing digital content into the memory of the inductively powered transponder device; packaging the product and physically associated inductively powered transponder device so as to prevent sufficient power from reaching an antenna of the inductively powered transponder device to enable the digital content to be read from the memory.

22. A method as claimed in claim 21, wherein packaging the product comprises shielding the antenna of the inductively powered transponder device to prevent it from receiving sufficient power.

23. A method as claimed in claim 21, wherein packaging the product comprises providing an absorbing device to prevent the antenna of the inductively powered transponder device to prevent it from receiving sufficient power.
